(19) United States
(12) Patent Application Publication
(10) Pub. No.: US 2016/0106609 A1
(43) Pub. Date: Apr. 21, 2016

(54) BEDPAN LINER AND TOILETING AID

(71) Applicant: Natalee Camille Russell, Vacaville, CA (US)

(72) Inventor: Natalee Camille Russell, Vacaville, CA (US)

(21) Appl. No.: 14/885,245

(22) Filed: Oct. 16, 2015

Related U.S. Application Data
(60) Provisional application No. 62/065,110, filed on Oct. 17, 2014.

(51) Int. Cl. A61G 9/00; A47K 11/10

(52) U.S. Cl. CPC A61G 9/003; A47K 11/105; A61G 2203/90

(57) ABSTRACT

The bedpan liner includes multiple planar flexible layers of material with an underliner layer underlying a top layer. The underliner layer is substantially waterproof and the top layer is porous and preferably soft. An absorbent medium can be interposed between the top layer and the underliner layer, preferably confined to a central portion of the liner. A perimeter of the bedpan liner includes a drawstring associated therewith for gathering of the perimeter together after patient elimination thereon. In use, the bedpan liner is placed over a bedpan with central portions thereof tucked into a cavity of the bedpan and perimeter portions of the liner upon a structure on which the bedpan rests. A patient then eliminates waste into the bedpan and upon the liner. The drawstring of the liner is then pulled tight to capture the patient waste therein and the liner is removed from the bedpan.

### CROSS-REFERENCE TO RELATED APPLICATIONS

This application claims benefit under Title 35, United States Code §119(e) of U.S. Provisional Application No. 62/065,110 filed on Oct. 17, 2014.

### FIELD OF THE INVENTION

The following invention relates to bedpans and bedpan accessories for assisting individuals in eliminating bodily waste while supine in a bed. More particularly, this invention relates to liners and other planar accessories for use with bedpans and associated methods to improve the comfort and effectiveness of toileting with a bedpan.

### BACKGROUND OF THE INVENTION

Bedpans come in a variety of different shapes and styles and are formed from a variety of different materials. Common to most bedpans is the provision of a reservoir in a lower portion accessed through an opening in an upper portion which is typically surrounded by a broad rim. The bedpan is significantly wider and longer than it is high to facilitate relatively straightforward passage of the bedpan underneath a supine patient (or other individual), to allow the patient to relieve the patient's bowels or bladder without needing to get out of bed. While toileting in bed is a necessity for ill persons or those recovering, it is fraught with various problems such as being extremely uncomfortable for the patient; the patients often must stay on the bedpan for an extended time as they are in an un-natural position for elimination; the person's fragile skin clings to the bedpan surface and is subject to tearing when the bedpan is removed; the bedpan to skin contact allows for significant pressure and can contribute to development of pressure ulcers; patients become reluctant to use the bedpan as they suffer the consequences of toileting spills on the bed linens which now must be changed causing discomfort to a bed-bound or immobilized patient; those dependent on bedpan toileting suffer a loss of dignity for a natural body process due to the lack of a better toileting method.

Bedpan use is typically taught such that the bedpan is used alone and then the contents typically poured into a toilet and then cleaned for reuse. However, staff/caregivers improvise various absorbent materials to hold waste in the bedpan, such as filling the bedpan cavity with toilet tissue or placing multiple layers of various liners (e.g. washcloths, sheets, pads) or disposable sheets or pads under the bedpan in attempts to avoid or contain the inevitable spills. The emptying and cleaning process for the bedpan also provides several opportunities for potential cross-contamination of body fluids with surfaces and other persons.

It is also known in some instances to utilize a cover or liner with a bedpan. Such products are designed to fit over or within the bedpan to protect the bedpan. One bedpan cover includes an anti-odor absorbent pad or waste treatment powder that absorbs liquid waste and turns it into an odorless, spill-proof gel. Such pads are generally the same size as the bed pan to fit inside the bed pan.

In other instances, a reusable linen pad or disposable pad/sheet is known to provide a bed cover beneath the bedpan during use so that any spills impact the bed cover, rather than directly impacting the sheets on the bed. Such bed covers may be waterproof but do not interact with the bedpan other than to sit beneath the bedpan. These products, while somewhat beneficial often fail to avoid soiling of underlying sheets or making an excessive mess on the patient which cannot be effectively cleaned without significant movement of the patient and typically also changing the bed linens. Standards of good nursing care often require the measurement of body fluids upon voiding, but bed-bound toileting in a bedpan results in inaccurate measurements due to transfer of the fluids to a separate measuring device, unaccounted fluids that spill from the bedpan, and also poses another opportunity for cross-contamination with body fluids.

Accordingly, a need exists for an improved bedpan liner which is easily used with a bedpan and makes the bedpan use procedure highly likely to avoid soiling of sheets or excessive soiling of the patient. Other problems with use of existing bedpans with or without existing liners include the potential for infection and/or cross-contamination, excessive laundry expense in washing of soiled sheets and other linens, excessive use of disposable items to clean up spills, patient discomfort and loss of dignity associated with bedpan use, difficulty in training patients in bedpan use with existing systems, significant patient movement requirements, and the significant burden that bedpan use places on nursing and other hospital staff and home care givers.

### SUMMARY OF THE INVENTION

The bedpan liner of this invention can be used with a variety of different bedpans and generally is in the form of a planar multi-layer flexible structure. A perimeter of this structure can be rectangular or oval or circular and typically has a size approximately three times wider (more or less) and three times longer (more or less) than the dimensions of the bedpan with which it is to be used. This outer dimension of the liner could be decreased and still provide many of the benefits of this invention.

The liner has a multi-layer structure including at least two layers. The first layer is an underliner layer which is waterproof and most preferably formed of a plastic material which may be biodegradable. A soft top layer resides over the top of the underliner. This soft top layer is preferably soft to provide comfort for the patient (or other individual) and can either be an absorbent material or a somewhat porous soft layer which allow fluids to pass therethrough readily. In one embodiment, the soft top layer is similar to the skin contacting layer of a disposable diaper. The layers can be quilted together to keep them held together and to aid in patient comfort. Other techniques known in the textile arts or disposable paper arts can also be deployed to enhance the comfort of the liner when it contacts the patient.

A central region of the liner preferably includes absorbent material between the top layer and the underliner. This absorbent material can be any of a variety of different materials including gels which absorb liquids, solid absorbent materials such as cotton, absorbent polymers or any of a variety of materials which are typically utilized within disposable diapers. The size of the region with the absorbent material is preferably similar to a size of the bedpan so that the region of the liner having the extra absorbent material is aligned with the bedpan when the liner is placed over the bedpan. In alternative embodiments this extra absorbent material could conceivably extend throughout the entire liner, either with the same amount of extra absorbent material thickness as in the central region or with a thinner and lesser amount of extra absorbent material in the periphery of the liner.

A perimeter of the liner preferably has a drawstring therein which can be tucked between the underliner and the soft top layer, or can be provided by folding the entire multi-layer structure of the liner back upon itself and stitching (or bonding or otherwise attaching) it back to itself generally in the form of a hem, but leaving an opening for the drawstring. The drawstring is entirely contained within the liner at the periphery thereof except at at least one location where the drawstring exits through a hole (or holes) in this drawstring pocket. Most preferably two locations for drawstring exit are provided at opposite locations so that the drawstring(s) can most effectively be fully gathered to close the liner. The drawstring(s) can be attached at two interior locations to facilitate gathering of the liner into a pouch.

When the invention is to be used, the bedpan and liner are first oriented together with the extra absorbent material portion in the center of the liner pushed down into the bedpan. The remaining periphery portions of the liner extend laterally in all directions away from the bedpan. The patient is then maneuvered utilizing a variety of different techniques so that the bedpan is positioned in its typical desired position beneath the patient and with the liner extending in all directions away from the bedpan laterally beneath the patient. Because the liner has a soft top layer in contact with the patient's skin, comfort is maximized.

Next, the patient relieves the patient's bowels and/or bladder. Fluids and/or solids collect within the bedpan above the extra absorbent material of the liner tucked down into the bedpan reservoir. When the patient is done, the healthcare professional can maneuver the patient for removal of the bedpan in the same manner that the bedpan would typically be removed. Typically, this involves rolling the patient onto the patient's side. Because solids and liquids should be entrapped within the bedpan, there is little risk of any migration of fluids or solids outside of the bedpan. However, the healthcare professional can see if this is occurring before it passes beyond an edge of the liner so that corrective action can be taken to capture any such liquids or solids not within the bedpan.

Next, the healthcare professional or caregiver can typically utilize toilet paper or other materials to clean the patient and deposit the toilet paper or other cleaning materials into the bedpan reservoir on top of the liner. Finally, the periphery of the liner can be gathered together away from the patient and the drawstring pulled so that all of the liquids and solids are fully contained within the bedpan liner with its closed upper end cinched tight by the drawstring.

The bedpan can then be removed from the liner and, since the bedpan is typically not soiled, it can either be reused or sent to a sterilization station for inspection and potential sterilization. The sheets of the bed remain clean and the arduous and time consuming task of changing the sheets (and associated discomfort of the bed bound patient) is avoided.

The liner preferably is color coded to identify the biohazard presented by the bodily solids and fluids within the liner. Infection control requires that various protocols be followed depending on the bodily substances being handled. Color coding and/or other coding or labeling can be built into the product or added by a practitioner after use, such as by adding a coding label to the liner exterior which integrates into the infection control protocols for the facility. For instance, highly infectious patients might have a different label applied to the liner after use than less infectious patients and radiation or chemotherapy patients could have their used liner appropriately coded for later handling. If patient's body fluids must be collected for laboratory specimen analysis, the liner is a “clean” surface and facilitates such collection while greatly diminishing the possibility of cross-contamination of the specimen from an unclean bedpan.

Also, the liner can have a known initial weight so that it can be readily weighed very precisely to determine the weight of bodily fluids evacuated from the bowels and/or bladder of the patient. This liner thus facilitates accurate documentation of patient bodily elimination. Nursing documentation is often required to document the precise amount of waste. This bedpan liner facilitates documentation while also avoiding the necessity to transfer waste material to a separate measuring device and creating the additional expense of cleaning the device, inaccuracy of measurement and additional opportunity for cross-contamination.

The liner can be custom sized to fit with a particular bedpan or be provided in a generic fashion to work with a variety of different bedpans. If desired, an upper surface of the liner can have a marking thereon identifying a central portion of the liner which is to be tucked down into the bedpan to assist a healthcare worker in properly tucking a proper amount of the liner into the bedpan. However, the liner has a large margin of safety making it user friendly and not dependent on precise positioning.

While the liner is preferably planar for most convenient manufacturing thereof, it is conceivable that the liner could be fabricated with a depression built into the liner sized to fit within the bedpan, such as by stretching plastic forming the underliner, and by stitching the soft top layer with extra fabric to be provided with a three-dimensional contour including an upper planar surface for a periphery and a central planar surface for location adjacent a floor of the reservoir of the bedpan, and a lateral tapering surface which tapers from the upper periphery elevation to the lower central planar surface elevation. If the entire liner is formed of appropriate materials, it is conceivable that it could be flushed down a toilet. However, most typically it would be placed within a bin or other container for such bio-wastes for collection and proper disposal by appropriate personnel, such as in the same manner as disposable diapers.

### OBJECTS OF THE INVENTION

Accordingly, a primary object of the present invention is to provide a toileting aid to allow an individual to more comfortably and effectively eliminate bodily waste with a bedpan while supine in a bed.

Another object of the present invention is to provide a method for assisting an individual in toileting, to enhance comfort, decrease risk of skin tears or skin breakdown and to maintain containment of eliminated bodily waste while using a bedpan.

Another object of the present invention is to enhance the sanitation associated with using a bedpan and reduce risk of cross-contamination.

Another object of the present invention is to provide a system to more effectively allow healthcare professionals to assist individuals in using a bedpan while maintaining individuals' dignity and independence.

Another object of the present invention is to provide a bedpan liner which enhances the comfort associated with using a bedpan.

Another object of the present invention is to provide a bedpan liner which keeps the bedpan from becoming soiled during use and reducing risk of cross-contamination from cleaning bedpans.

Another object of the present invention is to provide a system and method for using a bedpan which decreases the propensity for soiling of bed linens.

Other further objects of the present invention will become apparent from a careful reading of the included drawing figures, the claims and detailed description of the invention.

### BRIEF DESCRIPTION OF THE DRAWINGS

FIG. 1 is a perspective view of the bedpan liner of this invention laying upon a top surface of a mattress or other underlying bed structure, and with a bedpan beneath the liner and resting upon the surface of the bed.

FIG. 2 is a perspective view of that which is shown in FIG. 1 and with portions of the bedpan liner cut away to reveal interior details of the bedpan liner and its configuration relative to a bedpan.

FIG. 3 is a full sectional view of the bedpan liner of FIG. 1 taken through a portion of the bedpan liner avoiding a central region thereof.

FIG. 4 is a full sectional view of the bedpan liner of FIG. 1, with the section taken through a central region thereof to reveal the absorbent medium contained in this central region of the liner, in this embodiment.

FIG. 5 is a top plan view of the bedpan liner of FIG. 1.

FIG. 6 is a perspective view of the bedpan liner of this invention after it has been removed from a bedpan and gathered together utilizing a drawstring to contain waste therein.

FIG. 7 is a flow chart identifying steps associated with a method of utilizing the bedpan liner and toileting aid of this invention.

### DESCRIPTION OF THE PREFERRED EMBODIMENT

Referring to the drawings, wherein like reference numerals represent like parts throughout the various drawing figures, reference numeral 10 is directed to a bedpan liner which can be used along with a bedpan B to assist an individual in toileting using the bedpan B. The liner 10 rests upon the bedpan B and with central portions of the liner 10 tucked into a cavity C of the bedpan B and also extends out to a periphery extending beyond the bedpan B to assist in containment of waste during utilization of the bedpan B by an individual.

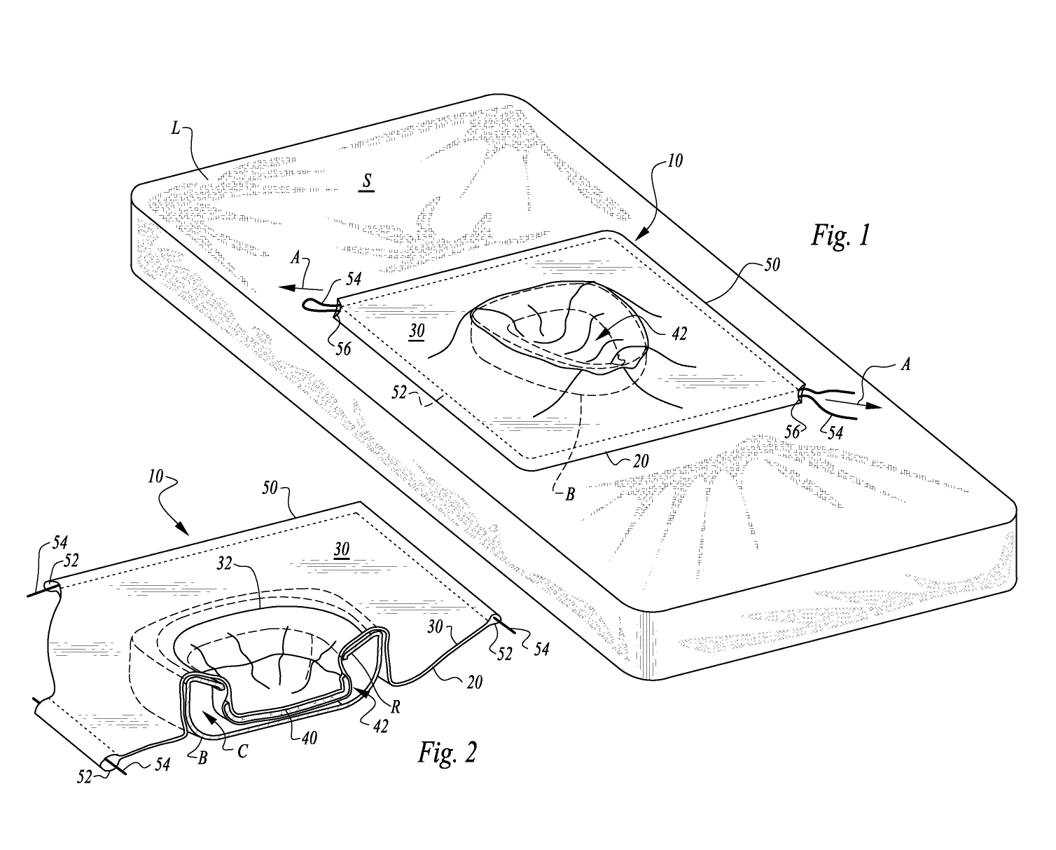

In essence, and with particular reference to FIGS. 1 and 2, basic details of the bedpan liner 10 are described, according to a preferred embodiment. The bedpan liner 10 is a multi-layer structure in this preferred embodiment, including an underliner layer 20 and a top layer 30. The underliner layer 20 is preferably waterproof and the top layer 30 is preferably porous. The top layer 30 is also preferably soft to present a comfortable surface for an individual. An absorbent medium 40 is preferably interposed between the top layer 30 and underliner layer 20, which absorbent medium 40 is preferably concentrated at a central region 42 of the liner 10. A perimeter 50 of the bedpan liner 10 is configured to support a drawstring 54 adjacent thereto. The perimeter 50 is sized sufficient to extend past the bedpan B in all directions and rest upon a surface S of a bed or other underlying structure, to assist in containment. The drawstring 54 can be gathered after utilization of the bedpan B to capture waste upon and within the liner 10 for effective containment and convenient disposal. The bedpan B, having been isolated by the liner 10, is ready for storage and future reuse with little or no sanitation of the bedpan B required.

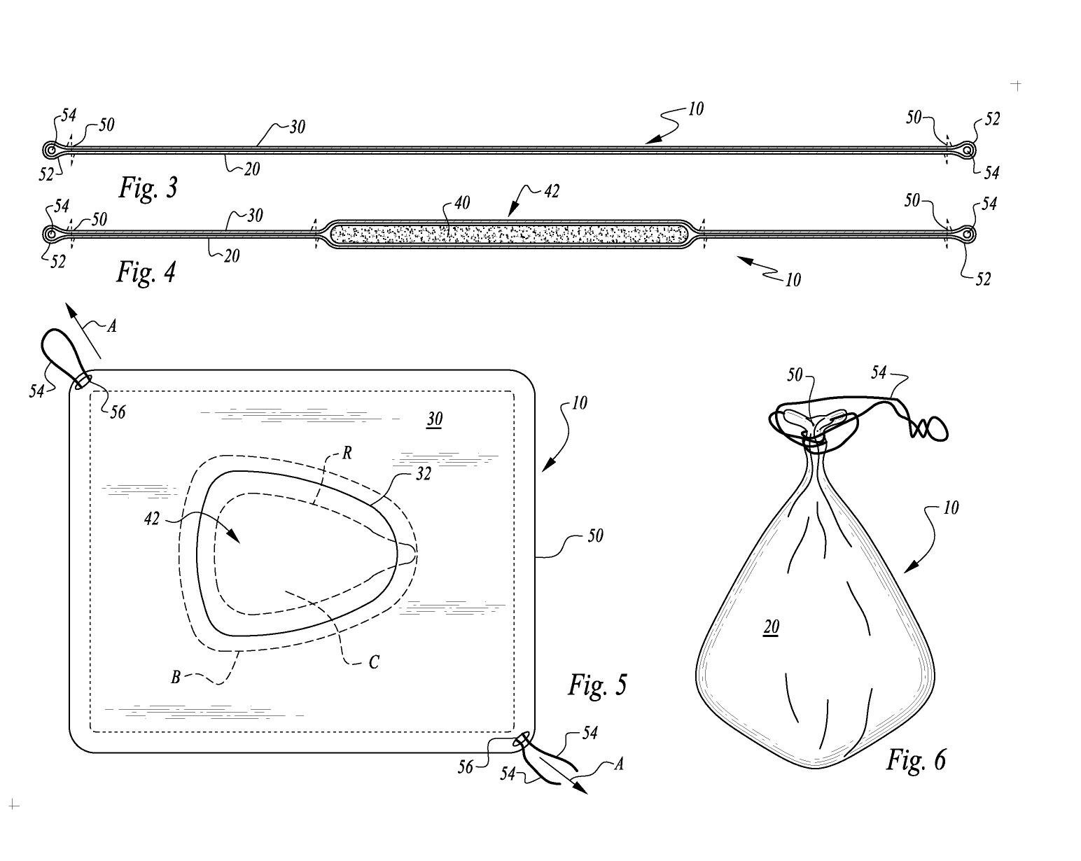

More specifically, and with continuing reference to FIGS. 1-4, details of the layers 20, 30, 40 forming the liner 10 are described, according to this preferred embodiment. The bedpan liner 10 preferably is formed of the underliner layer 20 and top layer 30 having similar dimensions extending out to the perimeter 50. The absorbent medium 40 optionally but preferably is provided between the underliner layer 20 and top layer 30 could have a similar dimension to the layers 20, 30, but most preferably is confined to a central region 42 inboard of the perimeter 50. In particular, this central region 42 (in one embodiment) has dimensions similar to that of a cavity C of the bedpan B inboard of a rim R of the bedpan B. In this way, the absorbent medium 40 can be located substantially entirely within the cavity C of the bedpan B when the central region 42 of the liner 10 is tucked into the cavity C of the bedpan B before use.

The underliner layer 20 is a planar thin flexible sheet of material that is preferably waterproof. In one embodiment, the underliner layer 20 is formed of a plastic material, most preferably a biodegradable plastic material such that it can decompose in a landfill or otherwise be more effectively recyclable and/or compostable. While the underliner layer 20 is shown as a single layer, multiple layers could be provided together of similar (or distinct) material to together establish the underliner layer 20. Providing multiple layers would provide some degree of redundancy should an individual layer be torn, to still provide full containment. Stitching is shown attaching the underliner layer 20 to adjacent layers, such as at the perimeter 50 and at a boundary of the central region 42. Such stitching could be provided to hold the underliner layer 20 to adjacent layers, or adhesive could alternatively be utilized. Furthermore, quilting can be utilized to secure the underliner layer 20 to other layers of the liner 10 at various different locations to keep the underliner layer 20 generally parallel to the top layer 30 of the bedpan liner 10. Quilting could be limited to placement between the top layer 30 and the absorbent medium 40 to avoid penetrating the underliner 20. To prevent leakage through the underliner 20, the material can be self-sealing after stitching therethrough or can be sealed after stitching, such as by applying heat to the plastic underliner 20, or laminating or otherwise adding a further layer to the underside of the underliner layer 20 after stitching.

The top layer 30 is a planar thin flexible sheet of material that provides the function of allowing liquids to pass therethrough and be captured within the overall bedpan liner 10. Furthermore, the top layer 30 is that portion of the bedpan liner 10 which comes into contact with skin of an individual utilizing the bedpan B. Thus, the top layer 30 is preferably formed of a soft material, such as a cotton or cotton blend fabric. Most preferably, the top layer 30 is also somewhat absorbent of liquids, as well as porous to allow liquids to pass through the top layer 30 and be more fully absorbed and held by the absorbent medium 40 beneath the top layer 30. In one embodiment, the top layer 30 is primarily only porous, while in other embodiments the top layer 30 emphasize its soft character.

The top layer 30 preferably includes a marking 32 thereon which bounds a central region 42 of the liner 10 which includes the absorbent medium 40 therein, or otherwise is provided as that portion of the liner 10 which should be tucked into the cavity C of the bedpan B. This marking 32 can be in the form of a line having a shape similar to a perimeter of a bedpan B, or could be a shaded region having a shape similar to that of a bedpan B. Instructions could also be printed on the top layer 30, such as “tuck shaded region into bedpan cavity.” The marking 32 can be slightly longer than the bedpan B to accommodate the central portion 42 of the liner 10 being tucked into the cavity C of the bedpan B and leave the marking 32 boundary near the rim R of the bedpan B.

The top layer 30 and underliner layer 20 are sufficiently large out to the perimeter 50 that the perimeter rests flat upon the surface S of the bed or other structure upon which the bedpan B is placed. Preferably no folds or creases are present at the perimeter 50. Rather, any creasing, folding, pleating or other non-planar contortions of the liner 10 are concentrated in the portion of the liner 10 tucked into the cavity C of the bedpan B.

While in one form of the invention the liner 10 could be comprised of only the underliner layer 20 and top layer 30, preferably an absorbent medium 40 is provided between the underliner layer 20 and the top layer 30. This absorbent medium 40 could be a material similar to that commonly provided within disposable diapers for holding of large amounts of liquid therein without spilling. In one embodiment this material includes an absorbent polymer. In another embodiment, the material can be more in the nature of a natural substance, such as cotton or other absorbent material.

The absorbent medium 40 can span the entire liner 10 inboard of the perimeter 50, but most preferably is concentrated at a central region 42 thereof. In this way, the absorbent medium 40 is tucked into the cavity C of the bedpan B, but does not extend out of the bedpan B appreciably. In this manner, the liquid waste is contained by the absorbent medium 40 within the bedpan B and further resists migration of eliminated liquids or other substances out of the bedpan B and toward a perimeter 50 of the bedpan liner 10. If desired, quilting, stitching or other fasteners such as adhesives can join the underliner layer 20 and top layer 30 together to contain the absorbent medium 40 at the central region 42 of the liner 10, or just join the top layer to the absorbent medium. If needed, a containment wrap can encapsulate the absorbent medium 40.

The bedpan liner 10 preferably includes a perimeter 50 which has an open hem 52 therein providing a tunnel adjacent the perimeter 50 in which a drawstring 54 can be located. This drawstring 54 passes through the open hem 52 and is fully contained therein, except where exit holes 56 are provided to allow for the drawstring 54 to be accessed. In one embodiment opposing diagonal corners of the perimeter 50 are provided with exit holes 56 so that the drawstring 54 can be grabbed in two locations. At a minimum, at least one exit hole 56 is provided. In other embodiments, more exit holes 56 could be provided, such as one at each corner of the perimeter 50 or even at midpoints along edges of the perimeter 50 between corners thereof. In one embodiment, the open hem 52 is provided by folding over each of the layers 20, 30 (or at least one of them) back onto themselves and stitching them together. In other embodiments the layers 20, 30 can be stitched at the perimeter 50 outermost edge as well as inboard of this outermost edge to provide the open hem 52 between these two stitching locations adjacent the perimeter 50.

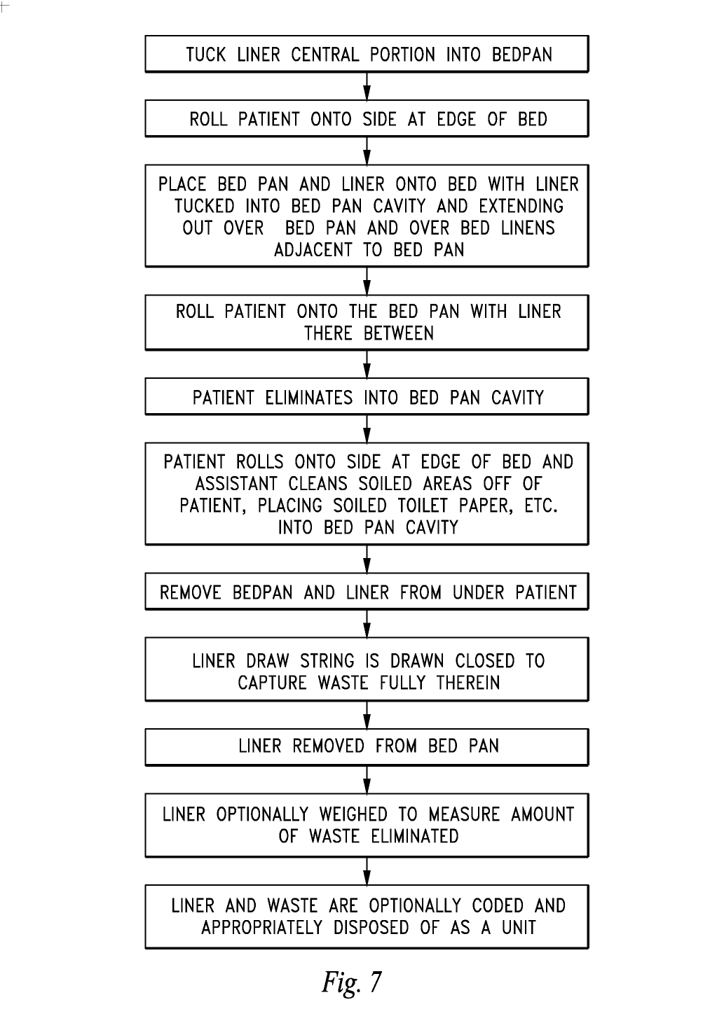

With particular reference to FIG. 7, details of the method of use of the bedpan liner 10 of this invention along with a bedpan B are described, according to a preferred embodiment. Initially, a patient which is resting supine upon a surface S, such as a mattress on a bed, is rolled onto the patient's side to expose the surface S (and typically linens L placed upon the surface S) to be fully available for placement of the bedpan B and bedpan liner 10. The bedpan B and liner 10 are placed upon the surface S, preferably with the central region 42 of the liner 10 tucked at least partially into the cavity C of the bedpan B (as shown in FIGS. 1 and 2). The portions of the liner 10 outside of the bedpan B extending out to the perimeter 50 are smoothed out into a thin fabric barrier to cover much of the surface S of the bed.

The patient is then rolled onto the bedpan B with the liner 10 between the bedpan B and the patient. The patient can then eliminate into the bedpan cavity C. The placement of the bedpan liner 10 causes the bedpan B to be isolated from the patient waste, with the patient waste accumulating upon the top layer 30 of the bedpan liner 10 and within the cavity C of the bedpan B. Liquid portions of the waste will pass through the top layer 30 and be absorbed by the absorbent medium 40.

Once the patient has completed elimination of waste, the patient rolls onto the patient's side at an edge of the bed and an assistant (or the individual) can clean soiled areas off of the patient, placing soiled toilet tissue, etc. into the bedpan cavity. The drawstring 54 of the liner 10 can then be drawn closed to fully capture patient waste therein. The liner 10 can be removed from the bedpan B. The bedpan B has avoided contact with the patient and should remain unsoiled so that it can be stored for reuse. No cleaning of the bedpan is required. All the patient waste has been captured within the liner 10 which has had its drawstring pulled closed (FIG. 6).

If desired, the liner 10 and waste can be weighed. A weight of the liner 10 before use is known so that it can be subtracted from the weight of the liner 10 plus waste. In this way, an accurate measurement of patient waste elimination can be identified. Such information can then be effectively charted and otherwise used in beneficially providing healthcare to the patient or other individual. Finally, the liner 10 and waste contained therein can be appropriately disposed of, such as in a bin provided for the containment of human waste.

With the drawstring pulled closed, and with the liner 10 having a waterproof underliner layer 20, the liner 10 provides ongoing containment of the waste, including odors associated therewith. Such a bin for containing waste provides an additional containment for such waste and potentially any such odors associated therewith. If the waste requires particular coding, such as to identify potential radioactivity if the patient is undergoing chemotherapy (or other coding), stickers can be placed on the underliner layer 20 exposed when the liner 10 is drawn closed with the drawstring 54. Alternatively, a marking pen can be utilized for such coding. Different bins can be provided for containment of human waste within bedpan liners 10 having different coding thereon. In this way, human waste can be effectively sorted for most appropriate disposal.

This disclosure is provided to reveal a preferred embodiment of the invention and a best mode for practicing the invention. Having thus described the invention in this way, it should be apparent that various different modifications can be made to the preferred embodiment without departing from the scope and spirit of this invention disclosure. When structures are identified as a means to perform a function, the identification is intended to include all structures which can perform the function specified. When structures of this invention are identified as being coupled together, such language should be interpreted broadly to include the structures being coupled directly together or coupled together through intervening structures. Such coupling could be permanent or temporary and either in a rigid fashion or in a fashion which allows pivoting, sliding or other relative motion while still providing some form of attachment, unless specifically restricted.

What is claimed is:

1: A method for aiding in the toileting of an individual while supine, including the steps of:
placing a bedpan upon a structure underlying the individual, the bedpan having a rim extending upward around a cavity;
positioning a liner over the bedpan and beneath the individual, the liner having a thin flexible form bounded by a perimeter which is sufficiently large to overlie both the bedpan and portions of the structure underlying the individual; and
tucking a central portion of the liner at least partially into the cavity of the bedpan.

2: The method of claim 1 wherein said positioning a liner step includes the liner being at least partially waterproof.

3: The method of claim 2 wherein said positioning a liner step includes the liner having at least two layers including a top layer and an underliner, the underliner being at least partially waterproof.

4: The method of claim 3 wherein said positioning a liner step includes the top layer being at least partially porous to allow liquids to pass through the top layer.

5: The method of claim 4 wherein said positioning a liner step includes locating an absorbent medium between the top layer and the underliner.

6: The method of claim 5 wherein said positioning a liner step includes the absorbent medium confined to the central portion of the liner inboard of a perimeter of the liner.

7: The method of claim 6 wherein said positioning a liner step includes the absorbent medium confined to a size similar to that of the bedpan of said placing a bedpan step, such that the absorbent medium is placed within the cavity of the bedpan of said placing step during said tucking step.

8: The method of claim 2 wherein said positioning a liner step includes providing a drawstring coupled to the liner adjacent a perimeter thereof.

9: The method of claim 8 wherein said positioning a liner step includes the liner having an open hem with the drawstring routed through the open hem, and with at least one exit hole extending out of the open hem.

10: The method of claim 9 wherein said positioning a liner step includes the liner having at least two layers including a top layer and an underliner, said underliner being at least partially waterproof, the drawstring located between the top layer and the underliner.

11: The method of claim 8 including the further step of gathering the drawstring tight after patient elimination to capture waste inboard of a perimeter of the liner.

12: The method of claim 11 including the further step of weighing the liner and patient waste together after said gathering step.

13: The method of claim 11 including the further step of coding the liner with a code to assist in proper disposal of the liner and waste therein after said gathering step.

14: A bedpan liner comprising in combination:
a multi-layer structure including an underliner layer which is substantially waterproof and a top layer overlying said underliner layer, said top layer formed of at least partially porous material; and
an absorbent medium interposed between said top layer and said underliner layer at a central region of said multi-layer structure.

15: The bedpan liner of claim 14 wherein said central region is sized similar to a bedpan.

16: The bedpan liner of claim 15 wherein said top layer is at least partially absorbent.

17: The bedpan liner of claim 15 wherein said absorbent medium includes a water absorbing polymer.

18: The bedpan liner of claim 14 wherein a drawstring extends along a periphery of a majority of said multi-layer structure.

19: The bedpan liner of claim 18 wherein said multi-layer structure includes an open hem at a perimeter thereof, said drawstring routed through said open hem.

20: The bedpan liner of claim 19 wherein said open hem includes at least one exit hole at which said drawstring can be grasped and pulled to gather said perimeter of said multi-layer structure together for containment of waste eliminated by an individual into the bedpan and upon said multi-layer structure.
